(19) United States
(12) Patent Application Publication
(10) Pub. No.: US 2026/0131248 A1
(43) Pub. Date: May 14, 2026

(54) SYSTEMS AND METHODS FOR VARYING GAMING EXPERIENCE USING GROUP SEGMENTATION

(71) Applicant: PLAYTIKA LTD., Herzliya Pituach (IL)

(72) Inventors: Kostiantyn SHYKUN, Kyiv City (UA); Illia BIEZHENUSOV, Warsaw (PL); Yuval MEY-TAL, Tel Aviv-Yafo (IL); Artem NAGRONYI, Herzliya Pituach (IL)

(73) Assignee: PLAYTIKA LTD., Herzliya Pituach (IL)

(21) Appl. No.: 19/385,115

(22) Filed: Nov. 10, 2025

Related U.S. Application Data
(60) Provisional application No. 63/718,143, filed on Nov. 8, 2024.

(51) Int. Cl. A63F 13/67

(52) U.S. Cl. CPC A63F 13/67

(57) ABSTRACT

A non-transitory computer readable medium containing instructions that when executed by at least one processor cause the processor to perform gaming experience variation operations based on group segmentation is provided. The operations include accessing, via a remote platform separate from a video game platform, multiple video game sessions associated with players who used the platform; collecting historical session data; segmenting the players into at least a first and second group based on the historical data; and imposing temporary changes in user experiences on the platform based on the segmenting, such that the first group is temporarily presented with a first altered experience and the second group is temporarily presented with a second altered experience different from the first. Methods and systems for performing gaming experience variation operations based on group segmentation are also provided.

### CROSS-REFERENCE TO RELATED APPLICATIONS

This application claims priority to U.S. Provisional Application No. 63/718,143, titled SYSTEMS AND METHODS FOR VARYING GAMING EXPERIENCE USING GROUP SEGMENTATION, filed Nov. 8, 2024, which is hereby incorporated by reference in its entirety.

### TECHNICAL FIELD

The present invention relates generally to video game platforms and, more specifically, to a system and method for varying gaming experiences provided by various video game platforms based on the segmentation of players into distinct groups.

### BACKGROUND

Video game platforms have become increasingly sophisticated, offering players immersive and engaging experiences across a wide range of genres. However, existing systems often struggle to provide personalized and dynamic gaming experiences that adapt to individual player behaviors and preferences. This limitation can lead to decreased player engagement and retention over time.

Current video game platforms typically offer a one-size-fits-all approach, where all players are presented with largely the same content and progression paths regardless of their individual playing styles, skill levels, or engagement patterns. While some games incorporate basic difficulty settings or branching storylines, these features often lack the granularity and responsiveness needed to truly cater to diverse player populations.

Additionally, many video game platforms face challenges in effectively segmenting their player base and delivering targeted experiences to different groups. Without robust segmentation capabilities, game developers and publishers may miss opportunities to re-engage dormant players, incentivize non-paying users to make purchases, or provide tailored content to highly active players.

Furthermore, existing systems for modifying game experiences are frequently limited in their flexibility and speed of implementation. Changes to game mechanics, content, or reward structures often require extensive development time and resources, making it difficult to respond quickly to shifting player behaviors or market trends.

The ability to dynamically alter gaming experiences based on player segmentation and historical data analysis remains a significant challenge in the industry. Current solutions may lack the technical infrastructure to collect and analyze player data in real-time, or they may be constrained by the underlying game architecture when attempting to implement temporary changes to user experiences.

These limitations in personalization, segmentation, and dynamic experience modification can result in reduced player satisfaction, lower retention rates, and missed monetization opportunities for game developers and publishers. As the video game industry continues to evolve, there is a growing need for more sophisticated systems that can adapt to individual player needs and behaviors while providing developers with greater flexibility in managing and modifying game experiences.

With the growth of online gaming and the increasing complexity of player behavior, it has become important to customize and optimize the gaming experience for different types of players. By segmenting players based on their historical behavior and imposing tailored gaming experiences, the disclosed systems and methods can enhance player engagement, retention, and monetization.

### BRIEF DESCRIPTION OF THE DRAWINGS

Non-limiting and non-exhaustive examples are described with reference to the following figures.

FIG. 1 illustrates an exemplary method for varying a gaming experience using group segmentation, consistent with disclosed embodiments.

FIG. 2 illustrates an exemplary system for varying a gaming experience using group segmentation, consistent with disclosed embodiments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Some exemplary embodiments are related to a non-transitory computer readable medium containing instructions that when executed by at least one processor cause the at least one processor to perform gaming experience variation operations based on group segmentation. The operations include accessing, via a remote platform separate from a video game platform, a plurality of video game sessions associated with a plurality of players who used the video game platform; collecting via the remote platform historical video game session data associated with the plurality of players; segmenting via the remote platform, the plurality of players into at least a first group and a second group based on the historical video game session data, wherein the at least the first group and the second group are selected from reactivated players, dormant players, paying players, non-paying players, players who reached one particular level, or players who reached another particular level; and imposing, via the remote platform, temporary changes in user experiences on the video game platform based on the segmenting, such that the first group is temporarily presented with a first altered experience and the second group is temporarily presented with a second altered experience different from the first altered experience.

Other exemplary embodiments are related to a system for performing gaming experience variation operations based on group segmentation. The system includes at least one processor configured to perform operations comprising: accessing, via a remote platform separate from a video game platform, a plurality of video game sessions associated with a plurality of players who used the video game platform; collecting via the remote platform historical video game session data associated with the plurality of players; segmenting via the remote platform, the plurality of players into at least a first group and a second group based on the historical video game session data, wherein the at least the first group and the second group are selected from reactivated players, dormant players, paying players, non-paying players, players who reached a one particular level, or players who reached another particular level; and imposing, via the remote platform, temporary changes in user experiences on the video game platform based on the segmenting, such that the first group is temporarily presented with a first altered experience and the second group is temporarily presented with a second altered experience different from the first altered experience.

Still further exemplary embodiments are related to a method for performing gaming experience variation operations based on group segmentation. The method includes accessing, via a remote platform separate from a video game platform, a plurality of video game sessions associated with a plurality of players who used the video game platform; collecting via the remote platform historical video game session data associated with the plurality of players; segmenting via the remote platform, the plurality of players into at least a first group and a second group based on the historical video game session data, wherein the at least the first group and the second group are selected from reactivated players, dormant players, paying players, non-paying players, players who reached a one particular level, or players who reached another particular level; and imposing, via the remote platform, temporary changes in user experiences on the video game platform based on the segmenting, such that the first group is temporarily presented with a first altered experience and the second group is temporarily presented with a second altered experience different from the first altered experience.

The foregoing general description of the illustrative embodiments and the following detailed description thereof are merely exemplary aspects of the teachings of this disclosure and are not restrictive.

### DETAILED DESCRIPTION

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

This disclosure may be described in the general context of customized hardware capable of executing customized preloaded instructions such as, e.g., computer-executable instructions for performing program modules. Generally, program modules include routines, programs, objects, components, data structures, and so forth, which perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

Exemplary disclosed embodiments include devices, systems, methods, and computer readable media for configuring varying gaming experiences based on group segmentation.

Some disclosed embodiments involve a non-transitory computer readable medium containing instructions that when executed by at least one processor causes at least one processor to perform gaming experience variation operations based on group segmentation.

The term “performing” refers to executing, carrying out, or implementing a set of actions or operations. For example, performing may involve executing computer instructions, processing data, or implementing algorithms to achieve a desired outcome.

The term “gaming experience variation operations” refers to one or more operations or strategies aimed at altering or enhancing the gaming experience for players, wherein such operations or strategies are configured on a remote platform separate from the video game platform. Such operations may involve configured changes in gameplay, game mechanics, user interface, rewards or promotions, attributes of the game, attributes outside the game, and other variations of the original gameplay of the game.

In this context, “gameplay” may refer to the overall experience of interacting with the game, including how the player engages with its challenges, objectives, and flow. For example, the game might adjust the pacing, available actions, or narrative progression to suit different player segments.

In this context, “game mechanics” may refer to the specific rules or systems that govern how the game operates and how players interact with it. For example, certain player groups might encounter altered movement controls, scoring methods, or resource management systems tailored to their play style.

In this context, “user interface” may refer to the visual and interactive elements that allow players to navigate and control the game. For example, novice players could receive simplified menus and tooltips, while advanced users might access more detailed settings or customizable layouts.

In this context, “rewards or promotions” may refer to in-game incentives or special offers provided to motivate or recognize player actions. For example, segmented groups might receive exclusive items, bonus points, or time-limited discounts based on their engagement patterns or achievements.

In this context, “attributes of the game” may refer to inherent elements such as graphics, sound design, story content, or available game modes. For example, some players might experience enhanced visual effects or access to unique storylines tailored to their group characteristics.

In this context, “attributes outside the game” may refer to external factors or features not directly part of the game itself, such as community forums, social integration, or support resources. For example, certain segments could be invited to participate in special online communities or receive personalized support communications.

In this context, “other variations of the original gameplay of the game” may refer to any additional changes or enhancements that modify the standard game experience for different player groups. For example, players might be offered unique challenge modes, custom event sequences, or experimental features not present in the base version of the game.

Such operations may also be operable via a remote platform, which allows for a third party or a party that is not directly associated with the video game platform to configure the changes without affecting the original gameplay experience for other players. Examples of gaming experience variation operations may include, e.g., dynamic difficulty adjustment, procedural content generation, player-centric customizations, event-driven changes, time-limited events or content, multiple player experience balancing, feedback loop integrations, adaptive user interfaces, artificial intelligence-driven modifications (e.g., for personalization or user engagement), changing game mechanics, or introducing new features.

In this context, “dynamic difficulty adjustment” may refer to the system's ability to automatically modify the challenge level of a game based on a player's performance or behavior. For example, if a player consistently overcomes obstacles with ease, the game could increase difficulty to maintain engagement.

In this context, “procedural content generation” may refer to the automated creation of game elements, such as levels, maps, or quests, using algorithms rather than manual design. For example, each playthrough might offer unique environments or challenges generated specifically for a player or group segment.

In this context, “player-centric customizations” may refer to tailoring game experiences or interfaces to individual player preferences or play styles. For example, the game might present personalized avatars, control schemes, or visual themes based on collected player data.

In this context, “event-driven changes” may refer to modifications in the game experience triggered by specific in-game or external events. For example, a special in-game event might temporarily alter the game world or offer limited-time rewards to certain player segments.

In this context, “time-limited events or content” may refer to experiences or items available only during a specific period, encouraging players to participate within that timeframe. For example, a seasonal quest or exclusive item might be accessible only for a week to segmented groups of players.

In this context, “multiple player experience balancing” may refer to adjusting gameplay elements to ensure fairness and enjoyment for players of varying skill levels within the same group or session. For example, the system might provide different support tools or challenges to each player based on their segment's characteristics.

In this context, “feedback loop integrations” may refer to mechanisms where player input or behavior continuously informs and shapes ongoing game adjustments. For example, the game could monitor player reactions to new features and dynamically refine or revert changes for improved engagement.

In this context, “adaptive user interfaces” may refer to interfaces that change layout, complexity, or available options according to the needs or preferences of different player groups. For example, novice players might see simplified menus, while experienced players access advanced controls.

In this context, “artificial intelligence-driven modifications” may refer to the use of AI algorithms to personalize or enhance the gaming experience based on real-time analysis of player data. For example, AI could suggest new challenges or content tailored to increase individual player engagement.

In this context, “changing game mechanics” may refer to altering the fundamental rules or systems of gameplay for different player segments. For example, one group might experience modified scoring systems or new movement rules to better suit their play style or engagement patterns.

In this context, “introducing new features” may refer to rolling out additional gameplay elements, tools, or content to specific groups as part of an engagement strategy. For example, a group of reactivated players might gain early access to a new multiplayer mode as an incentive to remain active.

A gaming experience, in this context, may refer to an experience that a player has while interacting with an online game (e.g., a video game). For example, a gaming experience may include signing up for a trial, registering as a player, playing a level, completing a stage, failing a stage, making a payment, receiving a payment or reward, or any other user interaction that might occur between the user and a video game or video game platform. An overall gaming experience may encompass a combination of elements that contribute to how enjoyable, immersive, and memorable a game is for the player of that game. The gaming experience may be shaped by various factors, including the game design, game mechanics, narrative, audiovisual presentation, and the player's personal preferences and context. The gaming experience may further be enhanced via gaming experience variation operations, as described and exemplified elsewhere herein. In the context of gaming, group segmentation may involve categorizing players based on factors such as playing habits, skill levels, or engagement patterns.

“Group segmentation” refers to the process of dividing a larger group of players (e.g., users associated with a video game platform) into smaller, more manageable subgroups wherein the subgroups include players having one or more shared characteristics, attributes, or criteria with respect to the video game platform or a particular video game.

In the context of the present disclosure, the phrase “performing gaming experience variation operations based on group segmentation” may refer to the process of implementing changes or modifications to a gaming experience for different groups of players, where these groups have been identified and categorized through a segmentation process. This may involve analyzing player data, dividing players into distinct groups, and then applying specific alterations or variations to the gaming experience for each group. In this context, “player data” may refer to information collected about individual players, such as gameplay history, behavioral patterns, preferences, and demographic details. For example, player data could include records of completed levels, time spent in-game, chosen character types, frequency of play, and responses to in-game events or offers.

By way of a non-limiting example, as described in detail below, a system may collect historical data on player behavior, segment players into groups such as “reactivated players” or “dormant players,” and then apply temporary changes to the gaming experience for each group. These changes may include presenting new game features, offering promotions, or adjusting game difficulty to enhance engagement and retention for specific player segments.

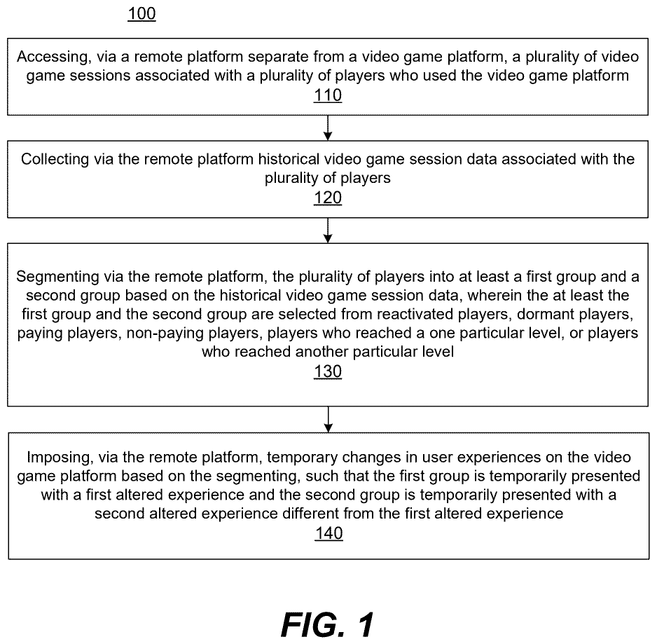

The operations performed by the at least one processor may mirror the steps of the methods described herein (e.g., method 100, as illustrated in FIG. 1). It will be understood that the steps or operations described herein may be duplicated, omitted, executed in any order, or modified to use in various situations.,

As exemplified in FIG. 1 at step 110, some disclosed embodiments involve accessing, via a remote platform separate from a particular video game platform, a plurality of video game sessions associated with a plurality of players who used (or have used) the particular video game platform.

The term “accessing” refers to the act of retrieving, obtaining, or gaining entry to data, information, or resources. In the context of computer systems, accessing may involve reading, fetching, or querying data from a storage device, database, or other data source.

Accessing, in this context, may refer to retrieving or interacting with data that is stored, e.g., on a server associated with the video game platform.

The term “remote platform” refers to a computing system, server, or infrastructure that is physically or logically separate from another system or platform. A remote platform may be connected to other systems via a network, allowing for data exchange and communication between different platforms.

A remote platform, in this context, may refer to a computerized platform that operates separately from a particular video game platform. The remote platform may be accessible to, e.g., a developer who wishes to configure changes to the gameplay of a particular video game platform based on user segmentation (as described further herein). The remote platform may be helpful to the developer who wishes to make changes to particular players'gameplay experiences without affecting the underlying code of the video game itself (e.g., without modifying the video game platform or the associated code itself, and instead configuring the changes via the remote platform).

The term “video game platform” refers to a hardware or software system designed for playing video games. This may include gaming consoles, personal computers, mobile devices, or cloud-based gaming services that provide the necessary infrastructure for running and interacting with video games.

A video game platform, in this context, may refer to a dedicated gaming console, which is designed exclusively for playing video games using proprietary hardware and software. A video game platform may also refer to a personal computer configured with gaming-specific hardware (e.g., graphics cards, controllers) and software environments, or to a mobile device like a smartphone running mobile gaming apps. Additionally, cloud-based gaming services, such as those that stream games over the internet without requiring local installation, represent another type of video game platform within the context of the present disclosure.

The term “video game sessions” refers to individual instances or periods of gameplay within a video game. A video game session may encompass the duration of a player's interaction with the game, including start and end times, in-game activities, and performance metrics. In this context, “in-game activities” may refer to the various tasks, actions, or events that players can participate in while engaged with a video game. For example, in-game activities could include completing quests or missions, participating in multiplayer battles, customizing characters or equipment, exploring virtual environments, or engaging in mini-games and challenges within the game world. In this context, “performance metrics” may refer to quantifiable measures that assess a player's effectiveness, progress, or skill within a video game. For example, performance metrics could include a player's score, win/loss ratio, completion time for specific objectives, accuracy rate, or number of achievements unlocked during gameplay.

Video game sessions, in this context, may refer to portions of video game data that are associated with a given player of the video game. Video game sessions may be completed video game sessions or incomplete sessions, and each session may be made up of various session data. In this context, “completed video game sessions” may refer to individual periods of gameplay that have reached a defined endpoint, such as when a player finishes a level, exits the game, or logs out from the platform. For example, a completed session could involve a player starting a match, playing through its duration, and then properly ending or saving their progress before leaving the game. In this context, “incomplete sessions” may refer to instances where a player begins a video game session but exits or disconnects before reaching a natural or intended conclusion. For example, an incomplete session could occur if a player leaves the game before finishing a level, quitting during a multiplayer match, or abruptly ending gameplay due to technical issues or intentional abandonment. In this context, “various session data” may refer to the diverse types of information collected during a player's interaction with a video game, such as login times, session durations, in-game actions, achievements, and communication logs. For example, various session data could include how long a player spent in each session, which game modes they participated in, the items or levels they accessed, and their messaging history with other players.

Further, session data may be accumulated by the remote platform and attributes may be assigned to players based on the accumulated session data associated with each player. In this context, “attributes” may refer to specific characteristics or properties associated with a player or a video game session, such as skill level, preferred game modes, or device type. For example, attributes could include a player's rank in competitive matches, their preferred control settings, or the genre of games they most frequently play.

As an example, session data may initially indicate that a player is dormant (as described and exemplified elsewhere herein), but over time, additionally accumulated session data may indicate that the player has returned from a dormant state. Based on the additionally accumulated session data, the remote platform may generate a new state for the player (e.g., from dormant to active, or active for a particular number of hours or days). In this context, an “active player” may refer to an individual who has recently participated in one or more video game sessions within a defined time frame and continues to engage with the gaming platform on a regular basis. For example, an active player might be someone who logs in and plays at least once per week, consistently interacts with in-game content, or regularly participates in multiplayer matches.

Furthermore, and based on the change of the player's state, the player may be eligible to be transferred from one group (e.g., of dormant players) to another group (e.g., of active players), as discussed in more detail further herein. A plurality of players, in this context, may refer to one or more players that are registered, assigned an identification number, or otherwise associated with the particular video game platform.

The term “players” refers to individuals who engage with and participate in video games. Players may interact with the game through various input devices and may have unique identifiers or profiles within the gaming system.

Players, in this context, may refer to a variety of entities. These include individuals who personally engage with and participate in gameplay, computing devices or automated agents that interact with games according to programmed behavior, or groups of people, such as teams, clans, or social communities who play collectively or collaboratively. The term can thus encompass solo participants, organized collectives, or even technological entities capable of interacting with a gaming system.

In the context of the present disclosure, the phrase “accessing, via a remote platform separate from a video game platform, a plurality of video game sessions associated with a plurality of players who used the video game platform” refers to the process of retrieving or obtaining information about multiple gaming sessions from a system that is distinct from the primary gaming infrastructure. This remote platform may collect, store, and analyze data from various gaming sessions across different players, allowing for centralized data management and processing separate from the core gaming experience. In this context, “processing separate from the core gaming experience” may refer to processes or systems that operate independently of the main gameplay environment, such as external data analysis or configuration platforms that do not directly alter a player's real-time interaction with the game. For example, a remote platform might analyze player behavior or adjust game settings in the background without affecting the actual play session or requiring any changes to the game's source code.

The remote platform may be configured to interface with one or more video game platforms to gather session data. This data may include, but is not limited to, player identifiers, game titles, session durations, in-game achievements, player performance metrics, and interaction patterns. In this context, “player identifiers” may refer to unique data elements—such as usernames, numeric IDs, or account credentials—that distinguish individual players within the video game platform. For example, a player identifier could be a user's gamertag, an email address linked to their gaming account, or a system-assigned numerical ID that is used to track their progress and activity across multiple sessions. In this context, “game titles” may refer to individual video games or software applications that are available on a particular video game platform. For example, a game title could be a popular first-person shooter, a sports simulation, or a puzzle game offered through the platform's library. In this context, “session durations” may refer to the length of time a player spends actively engaged in a single video game session. For example, session durations could be measured in minutes or hours, indicating how long each individual gameplay event lasts before a player exits or pauses the game. In this context, “in-game achievements” may refer to specific milestones, accomplishments, or objectives that players attain during gameplay, such as completing challenging tasks, reaching certain skill levels, or unlocking rewards. For example, achievements could include finishing the game on a hard difficulty setting, collecting all hidden items in a level, or earning a high score in a particular game mode. In this context, “player performance metrics” may refer to quantifiable data points that measure a player's effectiveness, skill level, and achievements within a video game. For example, these metrics may include scores, win/loss ratios, completion rates, levels attained, or the number of objectives completed during gameplay. In this context, “interaction patterns” may refer to the recurring ways in which players engage with a video game, such as the frequency, timing, and types of actions taken during gameplay. For example, interaction patterns might include how often a player joins multiplayer matches, their tendency to participate in cooperative versus competitive modes, or the sequences of activities they perform within each session. By accessing this information through a separate platform, the system may be able to perform analysis and operations without impacting the performance or functionality of the primary gaming platform.

The remote platform may employ various data retrieval methods to access the video game sessions. These methods may include periodic data synchronization, real-time data streaming, or on-demand queries to the video game platform's databases. The remote platform may use secure communication protocols to ensure the privacy and integrity of the accessed data.

By accessing multiple video game sessions across various players, the remote platform may be able to aggregate and analyze broader patterns of player behavior, game popularity, and engagement metrics. This capability may enable the system to make informed decisions about player segmentation and experience customization, as described in subsequent operations of the disclosed embodiments.

As exemplified in FIG. 1 at step 120, some disclosed embodiments involve collecting via the remote platform historical video game session data associated with the plurality of players.

The term “collecting” refers to the act of gathering, accumulating, or obtaining information or data from one or more sources. In the context of video game systems, collecting may involve retrieving, receiving, or compiling data from various game sessions, player interactions, or system logs.

The term “historical video game session data” refers to information or records related to past gameplay activities, interactions, or events that occurred during previous video game sessions. This data may include, but is not limited to, player performance metrics, in-game achievements, time spent playing, character progression, social interactions within the game, purchase history, and other relevant gameplay statistics.

Historical video game session data, in this context, may refer to data that has been generated or recorded over a period of time in the past and with relation to a particular video game platform. Such historical data may represent events, transactions, conditions, or other measurable factors that have occurred previously with respect to a video game platform and an associated player. It will be understood that the remote platform may collect (e.g., accumulate) current and future data in a similar fashion, as players continue to interact with the video game platform.

In the context of the present disclosure, the phrase “collecting historical video game session data” refers to the process of gathering and storing information about past gameplay experiences and player behaviors across multiple gaming sessions. This collection process may be performed by a remote platform that is separate from the video game platform where the actual gameplay occurs.

The remote platform may collect historical video game session data through various means. For example, the remote platform may receive data transmissions from the video game platform after each gaming session, periodically poll the video game platform for updated information, or maintain a continuous connection to receive real-time updates. The collected data may be stored in databases or other data storage systems associated with the remote platform for further analysis and processing.

By collecting historical video game session data, the remote platform may build comprehensive player profiles that capture long-term trends, preferences, and behaviors. In this context, “long-term trends, preferences, and behaviors” refers to patterns or tendencies in player activity, interests, and actions that emerge and persist over an extended period, rather than reflecting short-term or isolated events. For example, long-term trends may include a steady increase in the popularity of a particular game genre among players, preferences may involve a consistent choice of specific game modes or character types, and behaviors may encompass repeated patterns such as frequent in-game purchases, regular participation in seasonal events, or habitual engagement with cooperative multiplayer features. This historical data may serve as a foundation for various analytical processes, such as player segmentation, personalization of gaming experiences, and identification of patterns that may inform game design or marketing strategies.

The collection of historical video game session data may involve aggregating information from multiple sources within the gaming ecosystem. This may include data from individual game clients, server logs, matchmaking systems, in-game economies, and social features. The term “individual game clients” refers to the distinct software applications or programs installed on a user's device that enable direct interaction with a specific video game platform or service. These clients may serve as the interface through which players launch games, connect to servers, and access gameplay features. Examples of individual game clients may include clients for PC gaming or network clients on gaming consoles. Each client may manage, e.g., user authentication, game downloads, updates, and session data unique to the corresponding platform.

The term “server logs” refers to automatically generated files or records maintained by servers that document events, transactions, or activities occurring on a computer system or network. Server logs, in this context, may include information such as login attempts, user actions, system errors, resource usage, and communication between clients and servers. For example, server logs may record when a player connects to a game server, details of in-game transactions, server performance metrics, or error messages generated during gameplay.

The term “matchmaking systems” refers to automated or semi-automated mechanisms within video game platforms that pair or group players together for multiplayer sessions based on specific criteria, such as skill level, rank, geographic location, or player preferences. Examples of matchmaking systems may include ranked ladders that group competitors of similar skill, casual matchmaking that assembles players for quick, non-competitive matches, and party-based matchmaking that allows friends or pre-formed teams to be matched against other groups. Other examples may include region-based matchmaking, which reduces latency by connecting players from similar geographic areas, and role-based matchmaking, which organizes teams according to player-selected roles or character types.

The term in-game economies” refers to the mechanisms within a video game that manage the creation, distribution, exchange, and consumption of virtual goods, resources, or currency among players and the game environment. These economies may mimic real-world economic principles, enabling players to earn, spend, trade, or accumulate various assets in pursuit of in-game objectives. Examples of in-game economies may include virtual marketplaces where players can buy and sell items, auction houses for trading rare equipment, systems for earning and spending in-game currency, crafting and resource management systems, or player-driven trading networks for exchanging collectibles and cosmetic enhancements.

The term “social features” refers to interactive components within a video game platform that enable communication, collaboration, or social engagement among players. Social features may be designed to facilitate connections, foster community, and enhance player interactions both within and outside of actual gameplay. Examples of social features may include in-game chat systems, friend lists, player messaging, voice communication, clans or guilds, multiplayer lobbies, party formation, leaderboards, achievement sharing, and social media integration for posting game progress or inviting friends. Such elements may help build a sense of community and encourage ongoing participation in the gaming ecosystem.

The remote platform may also process and normalize this data to create a unified view of each player's gaming history across different titles or gaming platforms.

In some implementations, the collection process may involve data anonymization or pseudonymization techniques to protect player privacy while still allowing for meaningful analysis. The remote platform may also implement data retention policies to manage the storage and lifecycle of historical video game session data in compliance with relevant regulations and best practices.

As exemplified in FIG. 1 at step 130, some disclosed embodiments involve segmenting via the remote platform, the plurality of players into at least a first group and a second group based on the historical video game session data (and/or the accumulated video game session data), wherein the first group and the second group include players who are selected from one or more of the following player types: reactivated players, dormant players, paying players, non-paying players, players who reached one particular level, or players who reached another particular level.

The term “segmenting” refers to the process of dividing or categorizing a larger group into smaller subgroups based on specific criteria or characteristics. In the context of the present disclosure, segmenting involves dividing the plurality of players into distinct groups for targeted experiences or analysis.

The term “first group” refers to one subset of players resulting from the segmentation process. This group may be defined by specific characteristics or behaviors identified in the historical video game session data.

The term “second group” refers to another subset of players resulting from the segmentation process, distinct from the first group. This group may be defined by different characteristics or behaviors compared to the first group.

In the context of the present disclosure, the phrase “segmenting players into groups based on historical data” refers to the process of analyzing past player behaviors, preferences, and performance metrics to categorize players into distinct groups for targeted gaming experiences or analysis.

Each subgroup, or segment, may consist of individuals or players that share one or more common attributes with respect to the video game platform, the remote platform, or both platforms. Reactivated players, in this context, may refer to those players associated with a video game platform that have returned with activity after having been inactive, dormant, or deactivated for a period of time. The term “inactive” refers to players who have not engaged with a video game or its associated features for a certain period of time. For example, inactive players may be those who have not logged into the game, participated in gameplay sessions, made in-game purchases, or interacted with community features for durations such as 7, 30, or 90 days. Inactivity may also include players who have stopped completing quests, joining events, or responding to in-game notifications over a specified timeframe. The term “deactivated” refers to players whose accounts or access to a video game platform have been temporarily or permanently disabled, typically due to inactivity, policy violations, or user-requested account closure. For example, deactivated players may include those who have not accessed the game for an extended period, users who have violated community guidelines resulting in account suspension, or players who have chosen to disable their accounts through the platform's settings.

Dormant players, in this context, may refer to those players associated with a video game platform that are currently inactive but retain the potential to become active once more. Paying players, in this context, may refer to those players associated with a video game platform that provide a form of payment (e.g., are subscribed) to the video game platform. Non-paying players, in this context, may refer to those players associated with the video game platform that do not provide a form of payment to the video game platform (e.g., trial members). Players who reaches one particular level (or another particular level), in this context, may refer to those players associated with the video game platform that have reached a particular status or position based on successful activity (e.g., completing one or more stages or levels, reaching a checkpoint, remaining active for a threshold time period) within the video game. By segmenting players into particular groups which are associated with a given player type, varying altered gaming experiences may be provided to a plurality of players based on their grouping(s). As the remote platform continues to collect video game session data (historical data, accumulated data, or other data over time), the collection of data enables an association of attributes with each player. The association of attributes in turn enables for the players to be grouped (and re-grouped, when necessary) based on the associated attributes. Each group is associated with a particular configured altered gaming experience that may be created, via the remote platform, based on the player type associated with that group. When a player is added to a group (or when a player is removed therefrom), their gaming experience is altered accordingly to receive the configured changes (or to no longer receive the configured changes).

The remote platform may segment the plurality of players by analyzing various aspects of the historical video game session data. This data may include, but is not limited to, player engagement levels, in-game purchases, achievement rates, play frequency, session duration, and game preferences. The segmentation process may employ various algorithms or machine learning techniques to identify patterns and group players with similar characteristics or behaviors.

The term “patterns” refers to recurring trends, behaviors, or sequences that can be observed across multiple player experiences or within aggregated data sets. Patterns may manifest as repeated actions, habits, or responses that help identify commonalities among different players or groups. In this context, patterns may include players frequently logging in at certain times of day, consistently making in-game purchases after reaching specific milestones, or regularly participating in particular game modes. Other patterns might involve players tending to become inactive after completing a major quest, or showing increased engagement during special events or promotions.

The phrase “characteristics or behaviors” refers to identifiable attributes, actions, or patterns exhibited by players during their interactions with a video game platform. Characteristics may include demographic information, player status (such as new, returning, or veteran players), or other static qualities, while behaviors encompass measurable activities such as play frequency, engagement duration, in-game purchases, achievement completion, and participation in events or social features. For example, a characteristic may be a player's subscription status (paying or non-paying), and a behavior may be how often a player logs in, the number of levels completed over a specific period, or the frequency of in-game purchases made within a given time period.

By segmenting players into at least a first group and a second group, the remote platform may enable more personalized and targeted gaming experiences. For example, the first group may consist of highly engaged players who frequently make in-game purchases, while the second group may include players who have shown signs of decreasing engagement. This segmentation allows for tailored strategies to be applied to each group, potentially improving player retention and satisfaction.

In some disclosed embodiments, the segmenting occurs repeatedly, thereby rendering the first group and the second group non-permanent. In this implementation, the remote platform may perform the segmentation process at regular intervals or in response to specific triggers. This dynamic approach to segmentation allows for the continuous updating of player groups based on evolving behaviors and preferences. As a result, players may move between groups over time, ensuring that the categorization remains relevant and reflective of current player characteristics.

Additional disclosed embodiments involve, based on historical data changes over time, moving a particular player from the first group to the second group. This feature highlights the flexibility of the segmentation process. As a player's behavior or preferences change over time, as reflected in their updated historical data, the remote platform may reassign them to a different group. For instance, a player who was initially categorized in the first group due to high engagement may be moved to the second group if their engagement levels decrease significantly over time.

The dynamic nature of the segmentation process allows for more accurate and up-to-date player categorization. This, in turn, enables the video game platform to provide more relevant and personalized experiences to players based on their current behavior and preferences, potentially leading to improved player satisfaction and retention.

Some disclosed embodiments involve wherein the at least the first group and the second group are selected from reactivated players, dormant players, paying players, non-paying players, players who reached one particular level, or players who reached another particular level.

The term “reactivated players” refers to players who have returned to active participation in a video game after a period of inactivity. For example, reactivated players may include those who have not logged into the game for a specified time period (e.g., 30 days, 60 days, or 90 days) and have recently resumed playing.

The term “dormant players” refers to players who have not engaged with the video game for a specified period. For example, dormant players may include those who have not logged in, made in-game purchases, or participated in game activities for a predetermined duration (e.g., 14 days, 30 days, or 60 days).

The term “paying players” refers to players who have made monetary transactions within the video game ecosystem. For example, paying players may include those who have purchased in-game items, subscriptions, or virtual currency within a specified time frame (e.g., the last 30 days, 60 days, or 90 days).

The term “non-paying players” refers to players who have not made any monetary transactions within the video game ecosystem. For example, non-paying players may include those who have never made a purchase or have not made any purchases within a specified time frame (e.g., the last 30 days, 60 days, or 90 days).

The phrase “players who reached one particular level” refers to players who have attained a specific milestone or progression point within the video game. For example, this may include players who have reached a certain character level, completed a specific story chapter, or unlocked a particular game feature.

The phrase “players who reached another particular level” refers to players who have attained a different milestone or progression point within the video game, distinct from the “one particular level” mentioned previously. For example, this may include players who have reached a higher character level, completed a more advanced story chapter, or unlocked a more exclusive game feature.

In the context of the present disclosure, segmenting players into these groups may allow for targeted temporary changes in user experiences. For example, the remote platform may identify reactivated players and provide them with a special welcome-back experience to encourage continued engagement. Dormant players may receive notifications or incentives designed to re-engage them with the game. Paying players may be offered exclusive content or early access to new features, while non-paying players may be presented with attractive introductory offers to encourage their first purchase.

Players who have reached one particular level may be presented with challenges or content specifically designed for their skill level, while players who have reached another particular level may receive different, potentially more advanced, content. This segmentation and tailored experience approach may allow for more personalized and engaging gameplay experiences for different player groups, potentially increasing player retention and satisfaction.

The remote platform may use various data points and algorithms to categorize players into these groups. For example, login frequency, purchase history, progression data, and other relevant metrics may be analyzed to determine the appropriate group for each player. The platform may also employ machine learning techniques to refine and update these categorizations over time based on player behavior and responses to the altered experiences.

As exemplified in FIG. 1 at step 140, some disclosed embodiments involve imposing, via the remote platform, temporary changes in user experiences on the video game platform based on the segmenting, such that the first group is temporarily presented with a first altered experience and the second group is temporarily presented with a second altered experience different from the first altered experience.

The term “imposing” refers to the act of applying, implementing, or enforcing a particular condition, rule, or experience. In the context of video game platforms, imposing may involve modifying game parameters, introducing new features, or altering the user interface to create a specific gaming experience.

The term “temporary changes” refers to modifications or alterations that are not permanent and are intended to last for a limited duration. These changes may be reversed or removed after a specified period or upon meeting certain conditions.

The term “user experiences” refers to the overall interaction and engagement a player has with a video game or gaming platform. This may encompass various aspects such as gameplay mechanics, visual elements, audio features, rewards systems, and social interactions within the game.

In the context of the present disclosure, the phrase “imposing temporary changes in user experiences based on segmenting” refers to the process of applying time-limited modifications to the gaming environment or gameplay for specific groups of players, as determined by the segmentation process. These temporary changes may be tailored to each group's characteristics or behavior patterns to enhance engagement, retention, or other desired outcomes.

The system may implement these temporary changes through various means. For example, a step may involve modifying game parameters, introducing new game modes, or altering reward structures for specific player segments. The remote platform may communicate these changes to the video game platform, which then applies them to the relevant player groups.

As an example, a first group of users may be presented with a promotion via the user interface while a second group of users may be presented with a user prompt, wherein a correct answer by the user results in that user receiving the same promotion. As another example, the first and second groups of users may be presented with different promotions or rewards for a given amount of time (e.g., one minute, one hour, one day, or another time period based on the particular gameplay of a video game platform).

Some disclosed embodiments involve the first group being temporarily presented with a first altered experience and the second group being temporarily presented with a second altered experience different from the first altered experience.

The term “first altered experience” refers to a modified or changed interaction, gameplay, or user interface within the video game platform that is presented to the first group of players. This alteration may include, but is not limited to, changes in game mechanics, visual elements, available features, or reward structures that differ from the standard or previous game experience.

The term “second altered experience” refers to a distinct modified or changed interaction, gameplay, or user interface within the video game platform that is presented to the second group of players. This alteration may be different from both the standard game experience and the first altered experience presented to the first group.

The phrase “temporarily presented” in this context refers to the limited duration for which the altered experiences are made available to the respective groups. The altered experiences may be active for a predetermined time period, after which the standard game experience may be reinstated.

In the context of the present disclosure, “presenting different altered experiences to different groups” refers to the process of simultaneously offering distinct modifications to the video game platform for separate segments of the player base. This approach allows for targeted experimentation and personalized gaming experiences based on player segmentation.

The remote platform may implement these temporary changes in user experiences by modifying game parameters, unlocking specific features, or altering the game's content delivery for each group. For example, the first altered experience may involve presenting the first group with a new game mode or exclusive in-game items, while the second altered experience may offer the second group modified difficulty levels or unique storylines.

By presenting different altered experiences to different groups, the system may enable A/B testing of new features, targeted engagement strategies, or personalized content delivery. The term “A/B testing” refers to a method of comparing two or more variations of a product, feature, or experience to determine which performs better according to predefined metrics. For example, it may involve randomly assigning users to different groups and analyzing their interactions to identify the most effective option. This approach may allow game developers and platform operators to gather valuable data on player preferences and behaviors across different segments of their user base.

The temporary nature of these altered experiences may create a sense of exclusivity or urgency among players, potentially increasing engagement and retention. Additionally, it may provide flexibility for the platform to iterate and refine gaming experiences based on player feedback and performance metrics collected during these temporary alterations.

As a result, the system may optimize player engagement, retention, and monetization by tailoring experiences to specific player segments while maintaining the ability to revert to a common experience across all groups after the temporary period concludes.

Some disclosed embodiments involve reinstituting a common experience to the first group and the second group after expiration of a first time-period of the first altered experience and expiration of a second time period of the second altered experience.

The term “common experience,” refers to a gameplay experience (or altered experience) presented to both the first and second groups of users.

In this context, “reinstituting a common experience” refers to reverting the game environment or gameplay back to a standard or default state that is shared by all player groups (or at least the first and second groups of users). The system may track the duration of the altered experiences for each group and automatically revert the changes once the specified time periods have elapsed.

Some implementations may involve presenting the first group of players with a new game different from a previously presented game as part of the first altered experience. This new game may be designed to appeal to the specific characteristics or preferences of the first group, as determined by the segmentation process. The system may utilize the user interface to introduce and provide access to this new game for the targeted players.

In certain cases, the new game may be presented to the first group for a limited period of time. This time-limited availability may create a sense of exclusivity or urgency, potentially increasing player engagement. The system may use input output devices to display countdown timers or other visual indicators of the limited availability.

Additional disclosed embodiments involve presenting a notice to the first group that the new game is of a limited time duration. This notice may be displayed through the user interface, potentially as a pop-up message, in-game announcement, or other prominent notification to ensure players are aware of the time-sensitive nature of the new game offering.

In some implementations, the first altered experience may include presenting the first group of players with an altered game that varies at least in part from a previously presented game. This altered game may involve modifications to existing game mechanics, visual elements, or other aspects of the gameplay experience. The system may implement these alterations through updates or patches applied to the game client on the players'devices.

Similar to the new game scenario, the altered game may be presented to the first group for a limited period of time. The system may use the user interface to indicate the temporary nature of these alterations, potentially through visual cues or time-remaining indicators within the game environment.

Additional disclosed embodiments involve presenting a notice to the first group that the altered game is of a limited time duration. This notice may be conveyed through various means, such as in-game messages, email notifications, or push notifications, depending on the communication channels available to the system.

Some implementations involve presenting the first group of players with additional rewards not presented to the second group as part of the first altered experience. These additional rewards may be tailored to the characteristics or preferences of the first group, as determined by the segmentation process. The system (e.g., system 200) may use the user interface to highlight these exclusive rewards and make them easily accessible to the targeted players.

In some embodiments, the first altered experience may include presenting the first group of players with a promotion not presented to the second group. This promotion may be designed to incentivize specific behaviors or increase engagement among the first group. The system may utilize input output devices to display promotional banners, pop-up messages, or other visual elements to communicate the exclusive offer to the targeted players.

By implementing these temporary changes and tailored experiences, the system may enhance player engagement, retention, and satisfaction across different segments of the player base. The ability to dynamically adjust user experiences based on segmentation data allows for more personalized and potentially more effective gaming experiences.

In some embodiments, the first altered experience may include presenting the first group of players with additional rewards not presented to the second group.

The term “rewards” refers to various benefits or incentives given to players for participating in gaming experience events, completing specific tasks within video games, achieving certain milestones within a video game, or for another monetizing reason. Rewards, in this context, may include, e.g., additional in-game currency, exclusive items within the game, game experience points, limited-time offers within the game, in-game achievement badges, new in-game content, boosts, powerups, or other features that encourage engagement within a game and enhance the gaming experience. For example, the first altered experience may include presenting exclusive in-game items to the first group of players and not presenting the same items to the second group of players.

In some embodiments, the first altered experience may include presenting the first group of players with a promotion not presented to the second group.

The term “promotion” refers to one or more marketing features or other strategies used to encourage player engagement, boost activity, or drive monetization outside of a particular video game platform (e.g., to another video game platform). Promotions, in this context, may involve offering players additional incentives or bonuses to participate in specific activities or to take advantage of limited-time offers related to another video game or other online activity (e.g., a related video game created by the same developer, a raffle or competition created by a third party).

In some embodiments, the segmenting of players into groups may occur repeatedly and dynamically (e.g., based on accessed or accumulated video game session data), thereby rendering the first group and the second group non-permanent. The term “non-permanent” refers to something that is temporary or subject to change, removal, or cessation after a certain period of time. A result of the repeated segmenting is a fluidity that causes the groups to be dynamic, such that users who are re-assigned to a different group (e.g., based on accumulated video game session data that changes the attributes associated with the player) may automatically receive different variations of the gameplay experience, as dictated by the particular group to which they are (re-)assigned.

In some embodiments, based on historical data changes over time, the operations may further include moving a particular player from the first group to the second group. Moving a particular player from the first group to the second group (or any other group) may result in an altered experience for that player, wherein the altered experience is dictated by the particular group. Each group may, in turn, be based on one or more attributes that are shared amongst group members. For example, the first group may include players that have been dormant for at least one week, while the second group may include players that have been dormant for at least one month. The historical data changes over time may include, e.g., login data associated with each player, and based on such data, when a player within the first group becomes associated with no login data for a month (after their last login), that player may automatically be transferred to the second group and removed from the first group. As a result of the transfer to the second group, the player would be presented with the altered experiences associated with players of the second group only.

Some disclosed embodiments involve a system for performing gaming experience variation operations based on group segmentation. The system may include at least one processor configured to perform operations. In some embodiments, the operations performed by the at least one processor of the system may mirror the steps of the methods described herein (e.g., method 100, as illustrated in FIG. 1). It will be understood that the steps or operations described herein may be duplicated, omitted, executed in any order, or modified to use in various situations.

According to disclosed embodiments, and as exemplified in FIG. 1, the operations performed by the at least one processor may include the following steps: accessing, via a remote platform separate from a video game platform, a plurality of video game sessions associated with a plurality of players who used the video game platform; collecting via the remote platform historical video game session data associated with the plurality of players; segmenting via the remote platform, the plurality of players into at least a first group and a second group based on the historical video game session data, wherein the at least the first group and the second group are selected from reactivated players, dormant players, paying players, non-paying players, players who reached a one particular level, or players who reached another particular level; and imposing, via the remote platform, temporary changes in user experiences on the video game platform based on the segmenting, such that the first group is temporarily presented with a first altered experience and the second group is temporarily presented with a second altered experience different from the first altered experience (as described elsewhere herein).

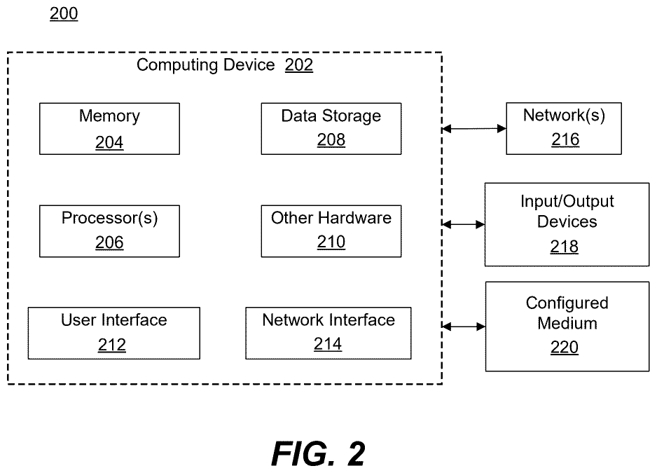

An exemplary system 200 for implementing various aspects of this disclosure is illustrated in FIG. 2. As illustrated in FIG. 2, an exemplary operating environment 200 may include a computing device 202 (e.g., a general-purpose computing device) in the form of a computer. In some embodiments, computing device 202 may be associated with a user. Components of the computing device 202 may include, but are not limited to, various hardware components, such as one or more processors 206, data storage 208, a system memory 204, other hardware 210, and a system bus (not shown) that couples (e.g., communicably couples, physically couples, and/or electrically couples) various system components such that the components may transmit data to and receive data from one another. The system bus may be any of several types of bus structures including a memory bus or memory controller, a peripheral bus, an address bus, a data bus, a control bus, and a local bus using any of a variety of bus architectures. By way of example, and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

As exemplified in FIG. 2, exemplary system 200 includes at least one computing device 202. The computing device 202 may be a uniprocessor or multiprocessor computing device. System 200 may include one or more computing devices (e.g., multiple computing devices 202) in a given computer system, which may be clustered, part of a local area network (LAN), part of a wide area network (WAN), part of a metropolitan area network (MAN), part of a wireless network, client-server networked, peer-to-peer networked within a cloud, or otherwise communicably linked. A network may include a vertical network, a chain network, a circuit network, a wheel or spoke network, a star network, or another type of network. A computer system may include an individual machine or a group of cooperating machines. A given computing device 202 may be configured for end-users, e.g., with applications, for administrators, as a server, as a distributed processing node, as a special-purpose processing device, or otherwise configured. In some embodiments, multiple computing devices 202 (e.g., a network of GPUs) may be configured together.

One or more users may interact with the computer system comprising one or more computing devices 202 by using a display, keyboard, mouse, microphone, touchpad, camera, sensor (e.g., touch sensor) and other input/output devices 218, via typed text, touch, voice, movement, computer vision, gestures, and/or other forms of input/output. An input/output device 218 may be removable (e.g., a connectable mouse or keyboard) or may be an integral part of the computing device 202 (e.g., a touchscreen, a built-in microphone). A user interface 212 may support interaction between an embodiment and one or more users. A user interface 212 may include one or more of a command line interface (CLI), graphical user interface (GUI), menu-driven user interface, voice user interface, touch user interface, form-based user interface, natural language user interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user input may also be used with the appropriate input devices, such as a microphone, camera, tablet, touch pad, glove, or other sensor. These and other input devices are often connected to the processing units through a user input interface that is coupled to the system bus, but may be connected by other interface and bus structures, such as a parallel port, a game port, or a universal serial bus (USB). A monitor or other type of display device may also be connected to the system bus via an interface, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the computing device may also include other peripheral output devices such as speakers, headphones, monitors, projectors, readers, or a printer, which may be connected through an output peripheral interface or the like.

One or more application programming interface (API) calls may be made between input/output devices 218 and computing device 202, based on input received at user interface 212 and/or from network(s) 216. As used throughout, “based on” may refer to being established or founded upon a use of, changed by, influenced by, caused by, dependent upon, or otherwise derived from. In some embodiments, an API call may be configured for a particular API, and may be interpreted and/or translated to an API call configured for a different API. In this context, an API may refer to a defined (e.g., according to an API specification) interface or connection between computers or between computer programs. An API specification may refer to a broad and language-agnostic description of how an API functions, data types supported by the API, the fundamental design philosophy of the API, and how the API links with other APIs.

Various types of users may interact with computing device 202 via one or more API calls and/or via a direct input via input/output devices 218. System administrators, network administrators, software developers, engineers, and end-users may each be a particular type of user. Automated agents, scripts, playback software, and the like, acting on behalf of one or more people, may also constitute a type of user. Storage devices and/or networking devices may be considered peripheral equipment in some embodiments and part of a system comprising one or more computing devices 202 in other embodiments, depending on their detachability from the processor(s) 206. Other computerized devices and/or systems not shown in FIG. 2 may interact in technological ways with computing device 202 or with another system using one or more connections to a network 216 via a network interface 214, which may include network interface equipment, such as a physical network interface controller (NIC) or a virtual network interface (VIF).

Computing device 202 may include at least one logical processor 206. The at least one logical processor 206 may include circuitry and transistors configured to execute instructions from memory (e.g., memory 204). For example, the processor(s) 206 may include one or more central processing units (CPUs), control units (CUs), arithmetic logic units (ALUs), registers, clocks, Floating Point Units (FPUs), and/or Graphics Processing Units (GPUs). The computing device 202, like other suitable devices, may also include one or more computer-readable storage media, which may include, but are not limited to, memory 204 and data storage 208. Computer-readable storage media may refer to any medium capable of storing data in a format that is easily processed by a digital computer or easily readable by a mechanical device. In some embodiments, memory 204 and data storage 208 may be part of a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 220 such as a portable (i.e., external) hard drive, compact disc (CD), Digital Versatile Disc (DVD), memory stick, mobile device, tablet device, USB device, or other removable non-volatile memory medium may become functionally a technological part of the computer system when inserted or otherwise installed with respect to one or more computing devices 202, making its content accessible for interaction with and use by processor(s) 206. The removable configured medium 220 is an example of a computer-readable storage medium. Some other examples of computer-readable storage media include built-in random access memory (RAM), read-only memory (ROM), hard disks, and other memory storage devices which are not readily removable by users (e.g., memory 204).

The configured medium 220 may be configured with instructions (e.g., binary instructions) that are executable by a processor 206; “executable” is used in a broad sense herein to include machine code, interpretable code, bytecode, compiled code, and/or any other code that is configured to run on a machine, including a physical machine or a virtualized computing instance (e.g., a virtual machine or a container). For example, an executable file may be a computer file that contains an encoded sequence of instructions that a system can execute directly when instructed by a user. The configured medium 220 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 210 such as Programmable Network Devices (e.g., switches, smart network interface cards), Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), Simple Programmable Logic Devices (SPLDs), and similar components. Components of an embodiment may be grouped into interacting functional modules based on their inputs, outputs, and/or their technical effects, for example.

In addition to processor(s) 206, memory 204, data storage 208, and screens/displays, system 200 may also include other hardware 210, such as batteries, buses, power supplies, wired and wireless network interface cards, additional input devices, additional processing devices, communication devices, persistent storage devices, and motherboards, for instance. The nouns “screen” and “display” are used interchangeably herein. A display may include one or more touch screens, screens responsive to input from a pen or tablet, or screens which operate solely for output. In some embodiment, other input/output devices 218 such as human user input/output devices (screen, keyboard, mouse, tablet, microphone, speaker, motion sensor, etc.) will be present in operable communication with one or more processors 206 and memory 204.

In some embodiments, system 200 may include multiple computing devices 202 connected by network(s) 216. Networking interface equipment can provide access to network(s) 216, using components (which may be part of a network interface 214) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches including but not limited to correspondence files, accounting systems, inventory-control systems, directories, indexing systems, and query systems.

The computing device 202 may operate in a personal environment, a private environment, or a networked or cloud-computing environment using logical connections to one or more remote devices (e.g., using network(s) 216), such as a remote computer (e.g., another computing device). The remote computer may include one or more of a personal computer, a server, a router, a network PC, or a mobile device or other common network node, and may include any or all of the elements described above relative to the computer. The logical connections may include one or more LANs, WANs, virtual networks, and/or the Internet.

When used in a networked or cloud-computing environment, computing device 202 may be connected to a public or private network through a network interface controller, a physical network interface, or a network adapter (e.g., a LAN or WAN adapter). A network interface or adapter may refer to a hardware component responsible for connecting a computing device to a computer network. In some embodiments, a modem or other communication connection device may be used for establishing communications over the network. The modem, which may be internal or external, may be connected to the system bus via a network interface or other appropriate mechanism. A wireless networking component such as one comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

Computing device 202 may also include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for an artificial intelligence model, and/or an artificial intelligence model itself) and which can be accessed by the computer. Communication media may embody computer-readable instructions, data structures, program modules or other data in a modulated data signal. The term “modulated data signal” means a signal that has one or more of its characteristics set or changed in such a manner as to encode information in the signal. By way of example, and not limitation, communication media includes wired media such as a wired network, direct-wired connection, analog or digital connection, twisted pair connection, coaxial connection, ethernet, or fiber optic connection, and wireless media such as acoustic, radio frequency (RF), infrared, broadcast, cellular, microwave, satellite, and other wireless media. Combinations of the any of the above may also be included within the scope of computer-readable media. Computer-readable media may be embodied as a computer program product, such as software (e.g., including program modules) stored on non-transitory computer-readable storage media.

The data storage 208 or system memory includes computer storage media in the form of volatile and/or nonvolatile memory such as ROM and RAM. ROM may refer to a type of computer storage containing non-volatile, permanent data that, normally, can only be read, not written to or changed. RAM may refer to a form of computer memory that can be read and written to or changed in any order. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 208 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Forms of data storage may include file storage, block storage, object storage, direct-attached storage, and/or network-based storage.

In this context, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

It will be apparent to those skilled in the art that various modifications and variations can be made for the integration of a software component into a software framework, the software framework, or the orchestration and integration of data, as executed by at least one processor. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. A non-transitory computer readable medium containing instructions that when executed by at least one processor cause the at least one processor to perform gaming experience variation operations based on group segmentation, the operations comprising:
accessing, via a remote platform separate from a video game platform, a plurality of video game sessions associated with a plurality of players who used the video game platform;
collecting via the remote platform historical video game session data associated with the plurality of players;
segmenting via the remote platform, the plurality of players into at least a first group and a second group based on the historical video game session data, wherein the at least the first group and the second group are selected from reactivated players, dormant players, paying players, non-paying players, players who reached one particular level, or players who reached another particular level; and
imposing, via the remote platform, temporary changes in user experiences on the video game platform based on the segmenting, such that the first group is temporarily presented with a first altered experience and the second group is temporarily presented with a second altered experience different from the first altered experience.

2. The non-transitory computer readable medium of claim 1, wherein the operations further comprise reinstituting a common experience to the first group and the second group after expiration of a first time-period of the first altered experience and expiration of a second time period of the second altered experience.

3. The non-transitory computer readable medium of claim 1, wherein the first altered experience includes presenting the first group of players with a new game different from a previously presented game.

4. The non-transitory computer readable medium of claim 3, wherein the new game is presented to the first group for a limited period of time.

5. The non-transitory computer readable medium of claim 4, wherein the operations further comprise presenting a notice to the first group that the new game is of a limited time duration.

6. The non-transitory computer readable medium of claim 1, wherein the first altered experience includes presenting the first group of players with an altered game that varies at least in part from a previously presented game.

7. The non-transitory computer readable medium of claim 6, wherein the altered game is presented to the first group for a limited period of time.

8. The non-transitory computer readable medium of claim 7, wherein the operations further comprise presenting a notice to the first group that the altered game is of a limited time duration.

9. The non-transitory computer readable medium of claim 1, wherein the first altered experience includes presenting the first group of players with additional rewards not presented to the second group.

10. The non-transitory computer readable medium of claim 1, wherein the first altered experience includes presenting the first group of players with a promotion not presented to the second group.

11. The non-transitory computer readable medium of claim 1, wherein the segmenting occurs repeatedly, thereby rendering the first group and the second group non-permanent.

12. The non-transitory computer readable medium of claim 11, wherein, based on historical data changes over time, the operations further include moving a particular player from the first group to the second group.

13. A system for performing gaming experience variation operations based on group segmentation, the system comprising:
at least one processor configured to perform operations comprising:
accessing, via a remote platform separate from a video game platform, a plurality of video game sessions associated with a plurality of players who used the video game platform;
collecting via the remote platform historical video game session data associated with the plurality of players;
segmenting via the remote platform, the plurality of players into at least a first group and a second group based on the historical video game session data, wherein the at least the first group and the second group are selected from reactivated players, dormant players, paying players, non-paying players, players who reached a one particular level, or players who reached another particular level; and
imposing, via the remote platform, temporary changes in user experiences on the video game platform based on the segmenting, such that the first group is temporarily presented with a first altered experience and the second group is temporarily presented with a second altered experience different from the first altered experience.

14. The system of claim 13, wherein the operations further comprise reinstituting a common experience to the first group and the second group after expiration of a first time-period of the first altered experience and expiration of a second time period of the second altered experience.

15. The system of claim 13, wherein the first altered experience includes presenting the first group of players with a new game different from a previously presented game.

16. The system of claim 15, wherein the new game is presented to the first group for a limited period of time.

17. The system of claim 16, wherein the operations further comprise presenting a notice to the first group that the new game is of a limited time duration.

18. The system of claim 13, wherein the first altered experience includes presenting the first group of players with an altered game that varies at least in part from a previously presented game.

19. The system of claim 18, wherein the altered game is presented to the first group for a limited period of time.

20. A method for performing gaming experience variation operations based on group segmentation, the method comprising:
accessing, via a remote platform separate from a video game platform, a plurality of video game sessions associated with a plurality of players who used the video game platform;
collecting via the remote platform historical video game session data associated with the plurality of players;
segmenting via the remote platform, the plurality of players into at least a first group and a second group based on the historical video game session data, wherein the at least the first group and the second group are selected from reactivated players, dormant players, paying players, non-paying players, players who reached a one particular level, or players who reached another particular level; and
imposing, via the remote platform, temporary changes in user experiences on the video game platform based on the segmenting, such that the first group is temporarily presented with a first altered experience and the second group is temporarily presented with a second altered experience different from the first altered experience.
